(19) United States
(12) Patent Application Publication
(10) Pub. No.: US 2011/0061681 A1
(43) Pub. Date: Mar. 17, 2011

(54) Pipeline Pig with Rupture Disc

(76) Inventor: Andrew Brian Cassidy, Wiltshire (GB)

(21) Appl. No.: 12/560,502

(22) Filed: Sep. 16, 2009

(51) Int. Cl. B08B 9/04

(52) U.S. Cl. 134/8; 15/104.061

(57) ABSTRACT

A cleaning and obstruction locating pipeline pig according to this invention includes a magnetic nose bumper at its forward end and a disc located in the central bypass flow passageway that prevents product from flowing through the central bypass flow passageway while the pig is travelling forward in the pipeline. If debris ahead of the pig causes the pig to become stuck in the pipeline, product flow pressing upon the disc ruptures the disc, thereby allowing product to flow through the central bypass flow passageway until the pig is located and removed from the pipeline. The pig may also be used to locate a previously launched but stuck pipeline pig.

### BACKGROUND OF THE INVENTION

This invention relates generally to a pipeline pig that services a pipeline and moves forward through the interior of the pipeline by the flow of pressurized gas or liquid. More specifically, this invention relates to a pipeline pig that is designed to locate a previously launched but completely stuck pipeline pig yet allow a certain percentage of flow through the pipe past the stuck pig.

Pipeline pigs for inspecting, servicing, and maintaining pipelines are typically moved along the interior of the pipeline under pressure. In some pigging applications, a certain amount of pipeline product may be allowed to flow through a central longitudinal passageway of the pig. Pipeline debris and build-up ahead of the pig may slow the pig below a desired minimum speed or completely prevent the pig from moving forward through the pipeline. Therefore, various passive and active speed control devices have been developed to regulate the amount of this bypass flow and therefore control the pig's speed.

Debris and build-up within the interior of a pipeline is problematic. Not only can it prevent the passage of pigs and other tools inspecting and servicing the pipeline, it reduces product flow, thereby increasing the pressure on valves and pumping equipment. If a pig encounters a partial blockage that stops the pig and pressure buildup behind the pig is not sufficient to get the pig moving forward again, the pig serves to restrict product flow through the pipeline downstream of the pig until the pig can be located and removed from the pipeline.

In an attempt to eliminate the build-up of ferrous debris within the pipeline, cleaning pigs have been developed that typically include a nose bumper with embedded magnets. However, debris and build-up can also prevent the passage of cleaning pigs. Unlike pigs used in other cleaning applications—such as inhibitor dispersal—or used in other pigging applications such as inspection operations, some cleaning pigs with their solid nose bumper (or other central obstruction) do not allow for bypass flow through the pig body. If the cleaning pig encounters a partial blockage that stops the pig and pressure buildup behind the pig is not sufficient to get the pig moving forward again, the cleaning pig serves to completely block product flow through the pipeline downstream of the pig until the pig can be located and removed from the pipeline. The longer that this no flow situation occurs, the more cost or lost revenue the pipeline operator incurs. Therefore, there is a need for a recovery pig that can remove ferrous debris ahead of the pig yet provide for continued bypass flow when a partial blockage causes the pig to become stuck in the pipeline. There is also a need for a recovery pig that can locate (or dislodge) a previously launched but stuck pipeline pig—in cases in which the stuck pig is still allowing for a certain percentage of bypass flow through the pig body—and provide continued product flow downstream of the obstruction until the pipeline operator performs a hot tap, bypass, and section removal procedure and removes the stuck pig. The recovery pig will also hold on to any metallic components on the stuck pig, allowing for accurate location of the stuck pig.

Pig designers have attempted to temporarily block bypass flow through the body of the pig by various active and passive speed control means as discussed above and through the use of temporary seals. For example, Freyer et al. (U.S. 2007/0286682) discloses a pipeline tool having a temporary seal illustrated in the form of a plug and located in the central bypass flow passageway of the tool. The tool is pushed along the interior of the pipeline by differential pressure contacting the body of the tool (as the primary means) and the temporary seal and guide discs disposed about the body (as secondary means). Once the tool is positioned at its intended location, a swellable component expands against the inner pipe wall to anchor the pipeline tool. The temporary seal, which is in the form of a plug body, permits isolation of the pipeline section upstream or downstream of the temporary seal. When the required maintenance, repair or upgrade operation is completed, the temporary seal is selectively opened to permit product flow to resume through the pipeline.

Freyer et al.'s temporary seal may be a rupture disc designed to burst open and relieve an over-pressure at a predetermined differential pressure. However, because the disc must remain intact for at least as long as it takes the swellable component to swell and sealably engage the pipeline wall, the rupture pressure must be well above the normal operating differential pressure experienced by the disc when the tool is moving forward through the interior of the pipeline. Because of this requirement, Freyer et al.'s rupture disc cannot rupture at the point in time when the tool comes to a dead stop. If the disc ruptures at this point, the purpose of the invention is defeated. Therefore, the tool cannot maintain product flow in the event that it encounters an obstruction that would cause it to stall. Furthermore, the tool cannot locate or adhere to a stuck pig body (or the metallic components of a stuck pig body) nor is it configured to remove ferrous debris ahead of the pig.

### SUMMARY OF THE INVENTION

A pipeline pig according to this invention includes a longitudinal body having at least two elastomeric sealing cups and a central bypass flow passageway extending between a forward and rearward end of the longitudinal body. A rupture disc is located in the central bypass flow passageway that prevents product flow from flowing through the flow passageway as the pig travels forward under differential pressure through the interior of a pipe or pipeline. The rupture disc may be held in place by a first and second flange half of the longitudinal body. The amount of product flow entering the central bypass flow passageway rearward of the rupture disc is limited by means such as a set of rear standoff spacers. When the pig comes to a complete stop because of debris—or because it has encountered a previously launched but stuck pipeline pig—the rupture disc ruptures substantially immediately. When the rupture disc ruptures, pipeline product flow entering the central bypass passageway is allowed to flow through the body of the pig while the pig waits to be retrieved by a pipeline operator.

The pig preferably includes a nose bumper located at a forward end that includes at least one embedded magnet. The nose bumper removes ferrous debris ahead of the pig and allows the pig to stick to the body of the previously stuck pig. A transmitter module towed by the pig transmits signals is used to pinpoint the exact location of the obstruction or blockage.

A method for locating an obstruction in a pipeline includes the steps of:
(a) launching a pipeline pig into a pipeline;
(b) limiting an amount of pipeline product flow entering a central bypass flow passageway of the pipeline pig;
(c) preventing the amount of pipeline product flow entering the central bypass flow passageway from flowing through the central bypass flow passageway when the pipeline pig is moving forward under differential pressure;
(d) encountering an obstruction ahead of the pipeline pig that stops the forward travel of the pipeline pig; and
(d) releasing the amount of pipeline product flow through the central bypass flow passageway when a pressure produced by the amount of pipeline product flow is at least as great as a predetermined differential pressure.

The pig preferably has a magnetic nose bumper for removing ferrous debris ahead of the pig and for sticking to the body of a previously launched but stuck pig that lies ahead of the pig. The releasing step may occur by way of a rupture disc located within the central bypass flow passageway of the pig. The rupture disc ruptures substantially instantaneously with the pig stopping because of the obstruction. The differential pressure at which the rupture disc ruptures is greater than a normal operating differential pressure but less than the cup blow over pressure and maximum pump pressure. The pig, as well as the obstruction encountered, may then be located and retrieved from the pipeline. However, product flow may still flow through the pig body while it waits to be retrieved.

### BRIEF DESCRIPTION OF THE DRAWINGS

FIG. 1 is a view of a preferred embodiment of a pipeline pig made according to this invention and located within a section of piping or pipeline. The pig includes two cylindrical-shaped body flange halves bolted together that provide for a predetermined amount of product flow to flow through the pig. The pig, which is moved forward within the pipeline by differential pressure, may tow an optional transmitter module that assists an operator in locating the pig should the pig become stuck in the pipeline and require retrieval.

FIG. 2 is a cross-sectional view of the pipeline pig of FIG. 1 taken along section line 2-2. The pig includes a centrally located rupture disc that prevents pipeline product flow through the pig body when the disc is in its intact (not ruptured) state.

FIG. 3 is a cross-sectional view of the transmitter module of FIG. 1 taken along section line 3-3. The transmitter module allows a predetermined amount of product flow to flow past it and to the pig body.

FIG. 4 is a view of the pipeline pig of FIG. 2 taken along section line 6-6.

FIG. 5 is a view of the pipeline pig of FIG. 1 illustrating the centrally located rupture disc in its ruptured state. When ruptured, the disc allows a predetermined amount of bypass flow through the pig body.

FIG. 6 is a view of the pipeline pig of FIG. 5 taken long section line 6-6.

FIG. 7 is a view of the pipeline pig of FIG. 2 taken along section line 7-7.

FIG. 8 is a view of the pipeline pig of FIG. 2 taken along section line 8-8. The nosepiece of the pig includes two magnets for use in removing ferrous debris as the pig moves forward through the pipeline.

### DETAILED DESCRIPTION OF THE PREFERRED EMBODIMENTS

Preferred embodiments of a pipeline pig with rupture disc will now be described by making reference to the drawings and the following elements illustrated in the drawings:

| | |
|---|---|
| 10 | Pipeline pig |
| 11 | Cylindrical body |
| 13 | Forward end |
| 15 | Rearward end |
| 17 | Central bypass flow passageway |
| 19 | Driving or sealing cups |
| 21 | Nose bumper |
| 23 | Magnet |
| 25 | First body flange half |
| 27 | Second body flange half |
| 29 | Towing means |
| 31 | Rear standoff spacers |
| 33 | Bypass flow area provided by 31 |
| 35 | Front standoff spacers |
| 37 | Bypass flow area provided by 35 |
| 40 | Transmitter module |
| 50 | Rupture disc |
| 51 | Rupture disc retaining flanges |
| 53 | Bypass flow area provided by 50 when ruptured |

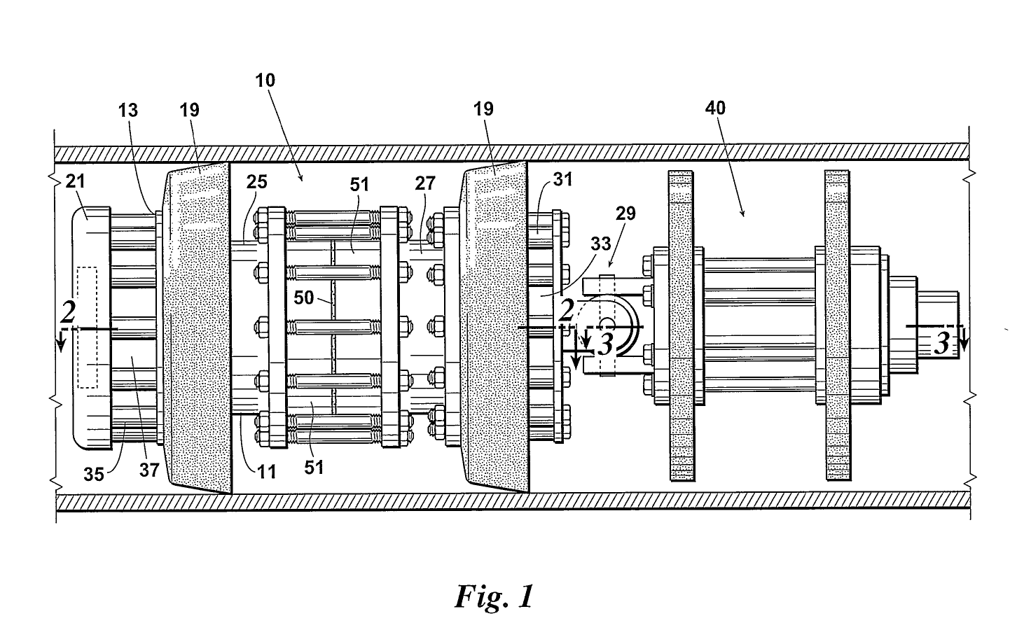

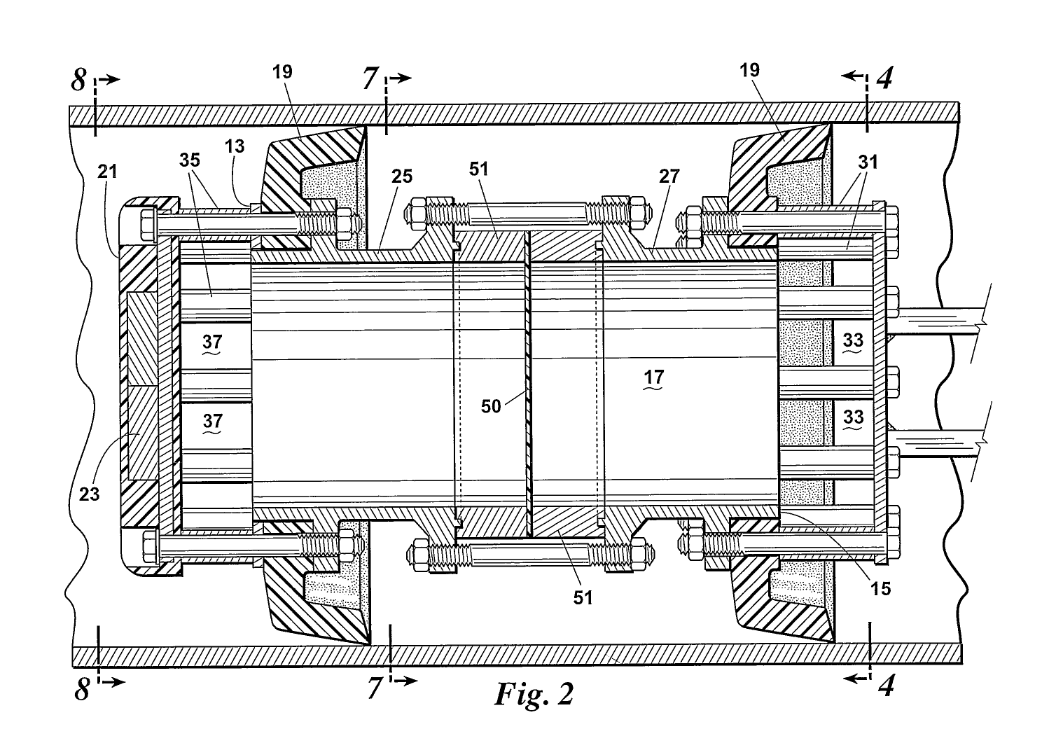

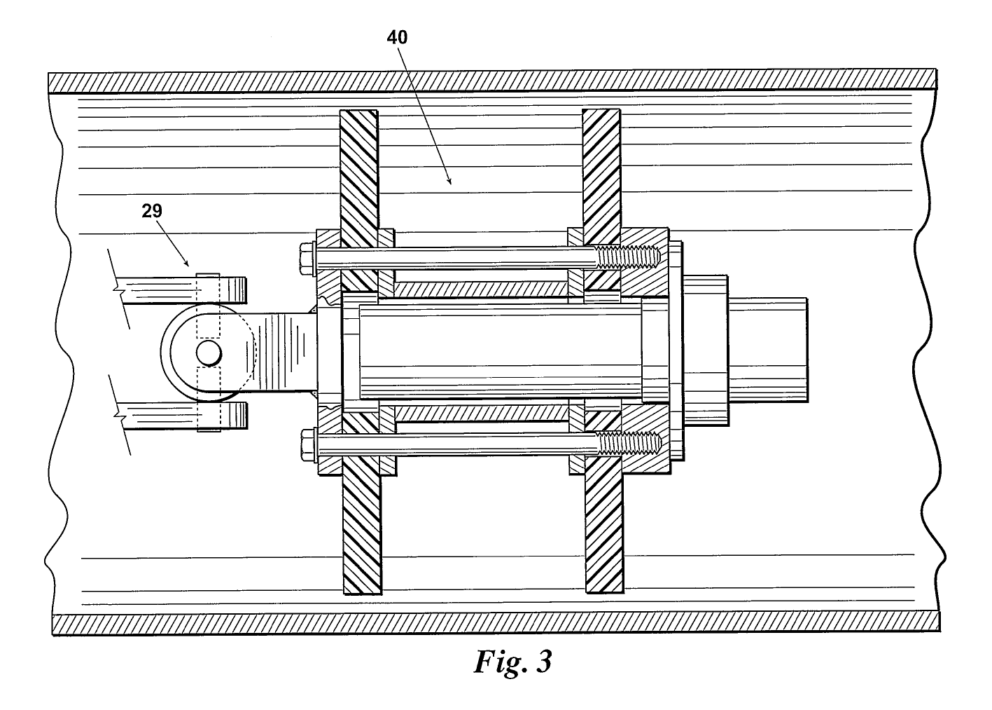

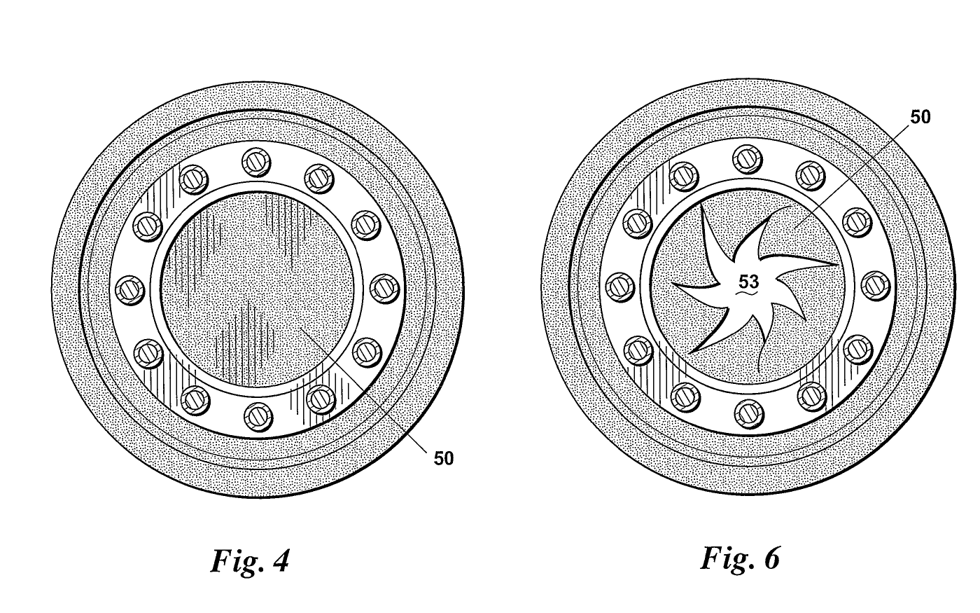

Referring to the drawings and first to FIGS. 1-4, a preferred embodiment of a pipeline pig 10 made according to this invention has a longitudinal cylindrical body 11 with a central bypass flow passageway 17 therethrough. Cylindrical body 11 may have a nose bumper 21 located at its forward end 13 and an optional towing means 29 located at its rearward end 15. Nose bumper 21 is preferably a plastic nose bumper with one or more embedded magnets 23 (see also FIG. 8) for picking up ferrous debris as pig 10 travels through the pipeline. Mounted at forward end 13 and rearward end 15 are driving or sealing cups 19 that provide sealing engagement with the inner wall surface of the pipeline in order to propel pig 10 forward under differential fluid pressure. Towing means 29, such as a universal joint, may be connected to a transmitter module 40 that is then towed behind pig 10. Transmitter module 40 is of a type well known in the art and includes means for locating pig 10 within a pipeline.

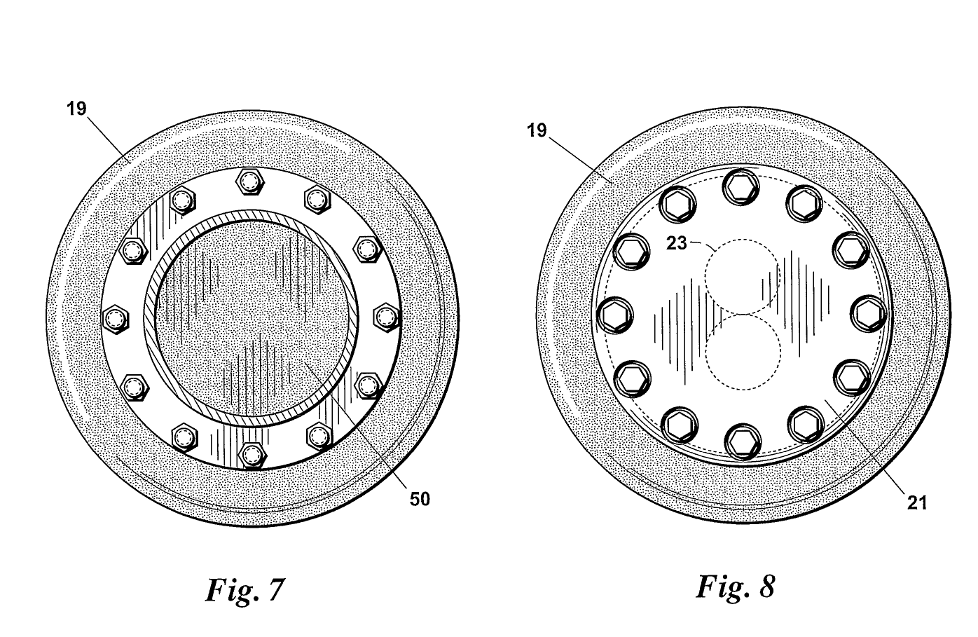

Cylindrical body 11 may be constructed of two separate body flange halves 25, 27 that, when bolted together, secure a pair of rupture disc retaining flanges 51 in between the two halves 25, 27. Retaining flanges 51, in turn, retain a rupture disc 50. Rupture disc 50, which may be a metallic foil disc or a urethane disc (see FIG. 7), prevents pipeline product flow that enters central passageway 17 through the bypass flow area 33 provided by spaced-apart rear standoff spacers 31 from flowing completely through central bypass flow passageway 17 and exiting the bypass flow area 37 provided by front standoff spacers 35. Rupture disc 50 is such that the driving pressure of pig 10 is not a sufficient pressure to rupture the disc 50.

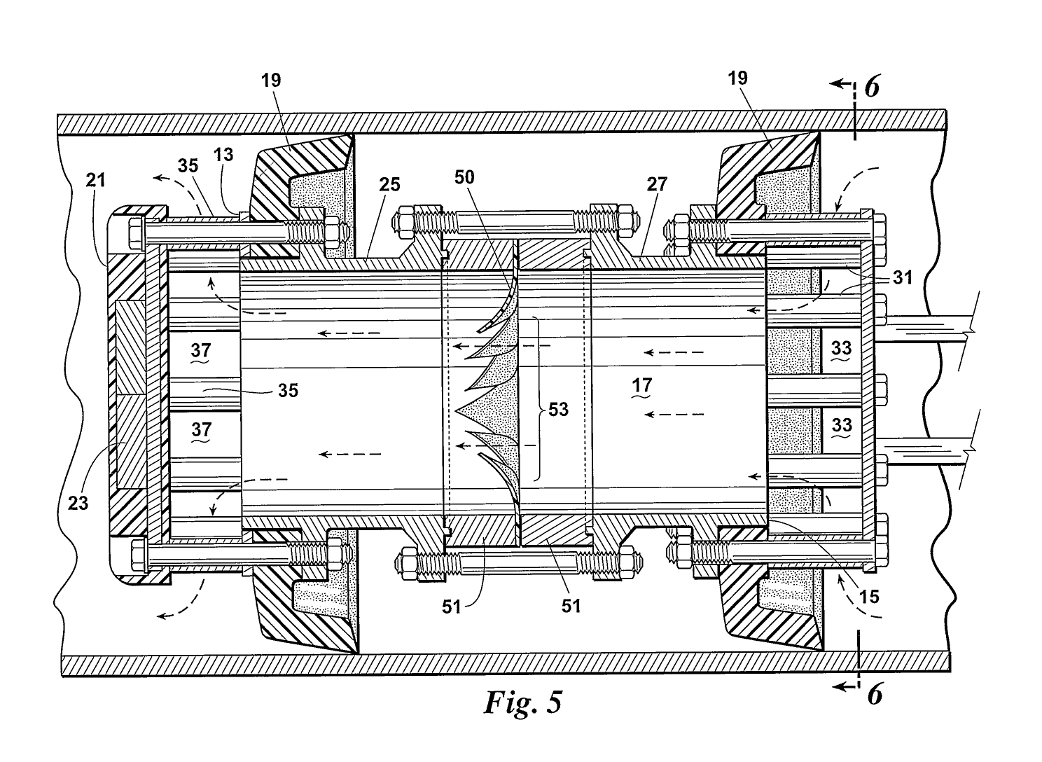

Referring now to FIGS. 5 & 6, pig 10 may become stuck within the pipeline and stop moving forward. As pig 10 encounters a blockage or a previously launched but stuck pipeline pig (not shown) pig 10 stops completely and differential pressure builds rearward of rupture disc 50 until it reaches a level of differential pressure that rupture disc 50 can no longer withstand (the “burst pressure”). This burst pressure occurs substantially immediately upon pig 10 stopping, allowing the exact location of the blockage or other pig to be pinpointed by the signal transmitted by transmitter module 40. The burst pressure is set above normal operating differential pressure, below the blow over pressure of sealing cups 19, and below the maximum pressure capacity of the pipeline product pump (not shown). A pipeline operator can be confident that when a pressure spike is observed—up to a predetermined value followed by a drop in pressure to a previous pressure reading—that either pig 10 is stuck or pig 10 has encountered a previously launched but stuck pipeline pig. In cases in which a stuck pipeline pig is encountered, the nose bumper 21 sticks to the body of the stuck pig (or some other metallic component of the pig) so that the blockage may be located by tracking the signal transmitted by transmitter module 40.

Once the burst pressure is reached, rupture disc 50 ruptures and a disc bypass flow area 53 through disc 50 is created. The portion of the pipeline product flow that enters through bypass flow area 33 and into central bypass flow passageway 17 may now flow downstream of disc bypass flow area 53 and through bypass flow area 37.

Disc bypass flow area 53 provides for a predetermined amount of bypass flow through pig 10 that may be substantially equal to the amount of bypass flow area 33, 37 provided by the front and rear standoff spacers 31, 35, respectively and individually. In a preferred embodiment designed for a 10-inch pig 10, front and rear standoff spacers 31, 35 each provide about a 25% bypass flow area 33, 37, respectively, and rupture disc 50 when ruptured provides about a 25% disc bypass flow area 51. Therefore, a 25% bypass flow is maintained throughout the length of pig 10. This design may be scaled up for larger sizes of pipe or scaled down for smaller size pipe (e.g. 2-inch size pipes).

While a pipeline pig with rupture disc has been described with a certain degree of particularity, many changes may be made in the details of construction and the arrangement of components without departing from the spirit and scope of this disclosure. A pipeline pig made according to this disclosure, therefore, is limited only by the scope of the attached claims, including the full range of equivalency to which each element thereof is entitled.

1. A pipeline pig comprising:
a longitudinal body having a bypass flow passageway extending between a forward and rearward end of said longitudinal body; and
a disc located between said forward and rearward end and arranged to prevent pipeline product flow from flowing through said bypass flow passageway as the pipeline pig travels forward under differential pressure within a pipeline;
said disc rupturing when the pipeline product flow pressing upon said disc is at least as great as a predetermined differential pressure;
said disc when ruptured allowing the pipeline product flow entering said bypass passageway to flow through said bypass flow passageway.

2. A pipeline pig according to claim 1 further comprising a nose bumper located at a forward end of said longitudinal body, said nose bumper including at least one embedded magnet.

3. A pipeline pig according to claim 1 further comprising said disc being a planar rupture disc.

4. A pipeline pig according to claim 1 wherein no portion of said disc when ruptured remains in the pipeline.

5. A pipeline pig according to claim 1 further comprising said longitudinal body including a first and second flange body half, said disc being retained between said flange body halves.

6. A pipeline pig according to claim 1 wherein the predetermined differential pressure is a differential pressure above a driving pressure of the pipeline pig.

7. A pipeline pig according to claim 1 wherein the predetermined differential pressure is a pressure exerted by the amount of pipeline product flow on said disc when the pipeline pig has stopped travelling forward within the pipeline.

8. A pipeline pig according to claim 1 wherein the predetermined differential pressure is a pressure greater than a normal operating differential pressure and less than a maximum pump pressure.

9. A pipeline pig according to claim 1 wherein the predetermined differential pressure is a pressure above normal operating differential pressure and less than a blow-over pressure of an elastomeric sealing means, said elastomeric sealing means providing sealing engagement with an inner wall of a pipeline to propel the pipeline pig forward under differential pressure.

10. A pipeline pig according to claim 1 further comprising means for limiting the amount of pipeline product flow entering a portion of said bypass flow passageway located rearward of said disc and pressing upon said disc.

11. A pipeline pig according to claim 10 further comprising said limiting means including a plurality of spaced-apart standoff spacers located rearward of said bypass flow passageway.

12. A pipeline pig according to claim 1 further comprising a transmitter module.

13. A method for locating an obstruction in a pipeline, the method comprising the steps of:
(a) launching a pipeline pig into a pipeline;
(b) preventing pipeline product flow from flowing through a bypass flow passageway when the pipeline pig is moving forward under differential pressure;
(c) encountering an obstruction ahead of the pipeline pig that stops the forward travel of the pipeline pig; and
(d) releasing the pipeline product flow through the central bypass flow passageway when a pressure produced by the pipeline product flow is at least as great as a predetermined differential pressure.

14. A method according to claim 13 wherein the pipeline pig includes a nose bumper located at a forward end of the pig, the nose bumper including at least one embedded magnet.

15. A method according to claim 13 wherein the pressure produced by the pipeline product flow is a pressure being exerted on a rupture disc.

16. A method according to claim 13 wherein the predetermined differential pressure is a pressure greater than a normal operating differential pressure and less than a maximum pump pressure.

17. A method according to claim 13 wherein the releasing step occurs substantially instantaneously with the encountering step.

18. A method according to claim 13 further comprising said preventing step including the sub-step of limiting the amount of pipeline product flow entering the bypass flow passageway of the pipeline pig.

19. A method according to claim 13 further comprising the steps of
(e) locating the obstruction within the pipeline; and
(g) retrieving the pipeline pig from the pipeline.

20. A method according to claim 13 further comprising said releasing step including the sub-step of limiting the amount of pipeline product flow flowing through the bypass flow passageway substantially instantaneously once the predetermined differential pressure is reached.
